(19) United States
(12) Patent Application Publication
(10) Pub. No.: US 2006/0024640 A1
(43) Pub. Date: Feb. 2, 2006

(54) Regulated pressure dental handpiece

(75) Inventors: Gary J. Pond, Racine, WI (US); Dale A. Lovrine, Burlington, WI (US)

Correspondence Address: RYAN KROMHOLZ & MANION, S.C., POST OFFICE BOX 26618, MILWAUKEE, WI, 53226, US

(73) Assignee: Inter-Med, Inc.

(21) Appl. No.: 11/023,251

(22) Filed: Dec. 27, 2004

Related U.S. Application Data
(60) Provisional application No. 60/592,722, filed on Jul. 30, 2004.

(51) Int. Cl. A61C 17/00

(52) U.S. Cl. 433/80

(57) ABSTRACT

A dental handpiece for delivering a fluid from a fluid source to a dental attachment under a regulated pressure. The said handpiece includes a head portion having a socket arranged to receive the dental attachment. A fluid passageway is in fluid communication with the socket and the fluid source. A fluid pressure control fitting resides in the passageway. The fitting has an orifice with a cross-sectional area less than said passageway interior cross-sectional area. The handpiece may be arranged for the delivery of more than one regulated fluid.

### RELATED APPLICATIONS

This application claims the benefit of co-pending provisional patent application Ser. No. 60/592,722, filed Jul. 30, 2004.

### BACKGROUND OF THE INVENTION

The present invention relates to dental handpieces for delivering fluid to a dental attachment. More specifically, the present invention relates to dental handpieces and devices in conjunction with dental handpieces that allow fluid to be delivered in a regulated manner.

It has been contemplated to simplify the regulation of fluids, such as air and water streams, for a dental syringe. Pressure regulators are commonly located near the supply source of the specific fluid. During a procedure, it may be necessary to change or adapt the pressure, in which case the dentist may have to stop the procedure, since the regulator controls may not necessarily be close to the dentist. Also, the operator must make sure that the pressure is properly calibrated before the dental tool is used. While syringes have been developed so that the dentist may change the flow of water or air directly from the handpiece, pressure regulation has generally not been possible through controls located in the handpiece.

Some dental devices have been designed with fluid flow controls located in the handpiece. However, these controls do not correct for differing source pressures to deliver a uniform fluid flow to the dental attachment. Thus, if the fluid delivery is not regulated at the proper pressure, the user must correct the fluid flow rate from the pressurized fluid source. It would be beneficial to design a handpiece that would automatically correct and regulate pressure of the fluid without undue intervention from the operator.

### SUMMARY OF THE INVENTION

The present invention is a dental handpiece for delivering a fluid from a fluid source to a dental attachment under a regulated pressure. The handpiece has a head portion having a socket being arranged to receive the dental attachment. The dental handpiece has a fluid passageway with a first end in communication with the socket and a second end in communication with the fluid source. A control valve intersects the passageway for controlling fluid flow within the passageway. The handpiece has a fluid pressure control fitting residing within the passageway. The fitting has an interior cross-sectional area less than that of the passageway cross-sectional area. The arrangement of the fitting allows pressure from an unregulated source to be delivered to the dental attachment in a regulated manner.

The invention also may be designed for delivery of multiple fluids to the dental attachment from multiple fluid sources. Each of the fluid passageways will have a pressure control fitting located within the passageway. Delivery of the fluids is accomplished with each of the fluids being under a regulated pressure, regardless of the pressure of the fluid source.

### BRIEF DESCRIPTION OF THE DRAWINGS

FIG. 1 is a diagrammatic view of fluid sources and a dental handpiece according to the present invention.

FIG. 2 is an exploded view of a dental handpiece according to the present invention.

FIG. 3 is a partially cut-away side view of the dental handpiece of FIG. 2 having an obstructed fluid passageway.

FIG. 4 is a partially cut-away side view of the dental handpiece of FIG. 2 having an unobstructed fluid passageway.

FIG. 5 is a top perspective view of a fluid pressure control fitting in accordance with the present invention.

FIG. 6 is a bottom perspective view of the fluid pressure control fitting of FIG. 5.

FIG. 7 is a diagrammatic view of a second embodiment of a dental handpiece according to the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention that may be embodied in other specific structures. While the preferred embodiment has been described, the details may be changed without departing from the invention, which is defined by the claims.

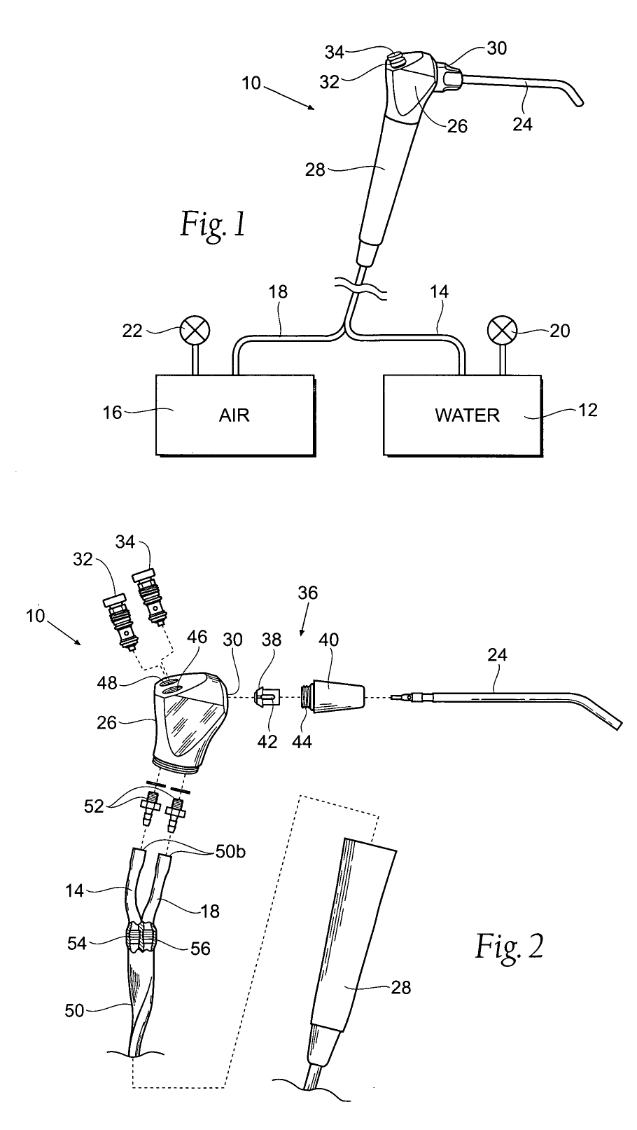

FIG. 1 is a diagrammatic view of a dental handpiece 10 in accordance with the present invention. The dental handpiece 10 is connected to a first fluid source 12 by a first supply line 14 and to a second fluid source 16 by a second supply line 18. As an example, the two fluids may be a water source and an air source. The first fluid source 12 and the second fluid source 16 each have a pressure control valve 20 and 22, respectively. The pressure control valves 20 and 22 generally act as on/off switches for the fluid sources 12 and 16, but will not be necessary to regulate pressure flow through the handpiece 10. The dental handpiece 10 provides regulated fluid to a dental attachment 24, which may be a syringe, needle, irrigator, aspirator, or any other attachment that may be used for dental procedures.

Still referring to FIG. 1, the dental handpiece 10 has a head portion 26 and a grip portion 28. The head portion 26 has a socket 30 to allow connection to the dental attachment 24. The socket 30 should be considered broadly to include any structure that allows the dental attachment 24 to be connected the handpiece 10. The head portion 10 also contains finger valves 32 and 34 for discharging fluids to the dental attachment 24 from the fluid supplies 12 and 16, respectively. The grip portion 28 gives the user an area to grasp the handpiece 10 without having to directly grasp the supply lines 14 and 18 and the dental handpiece 10.

FIG. 2 is an exploded view of the dental handpiece 10. An adaptor 36 is shown to connect the dental attachment 24 to the dental handpiece 10. As shown, the adaptor 36 comprises a valve member 38 and a coupling member 40. The valve member 38 comprises a through channel 42 that allows fluid to pass from the socket 30 to the dental handpiece in a fluid-tight arrangement. The valve member 38 sits within the coupling member 40, which has a threaded end 44 for retention in the socket 30. Generally, the adaptor 36 is of a sufficient structure that will allow secure and fluid tight connection of any of several dental attachments to be joined to the dental handpiece 10. It is understood that the present invention will work with a wide range of adaptors and dental attachments. The figures are merely exemplary of possible designs and should not be considered limiting on the invention.

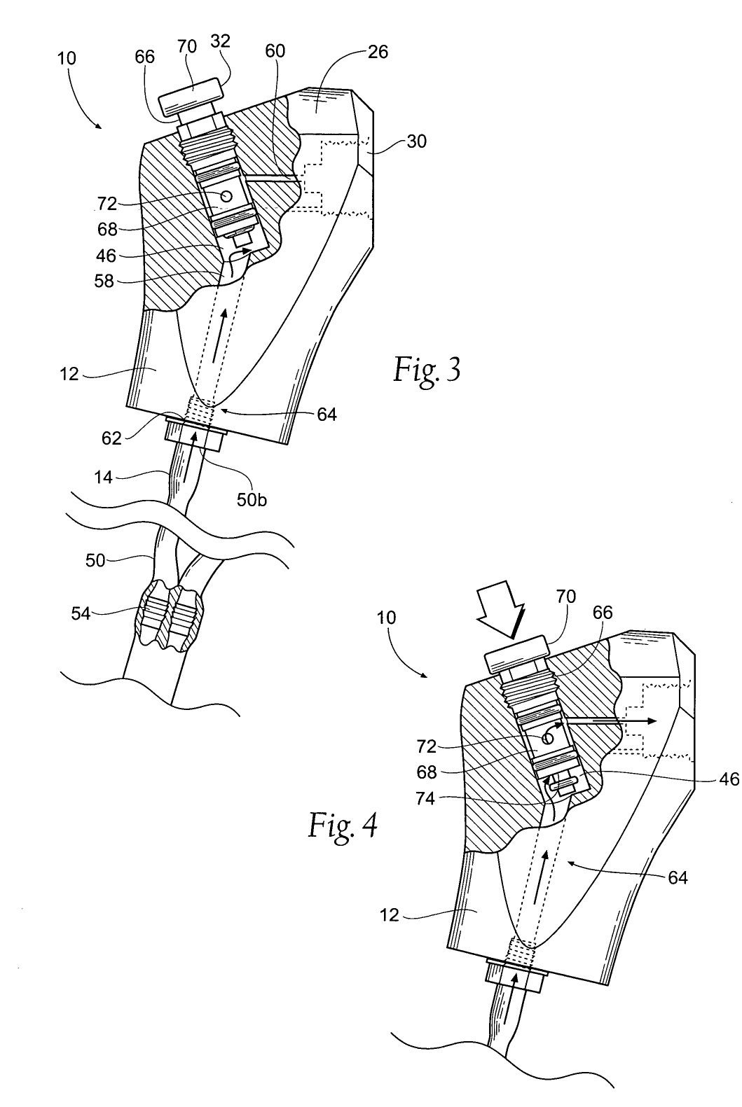

Still referring to FIG. 2, the finger valves 32 and 34 are shown removed from the head portion 26. The valves 32 and 34 are secured within cavities 46 and 48, respectively. Preferably the valves 32 and 34 are threaded into the cavities 46 and 48. The valves 32 and 34 and the cavities 46 and 48 will be discussed further with respect to FIG. 3.

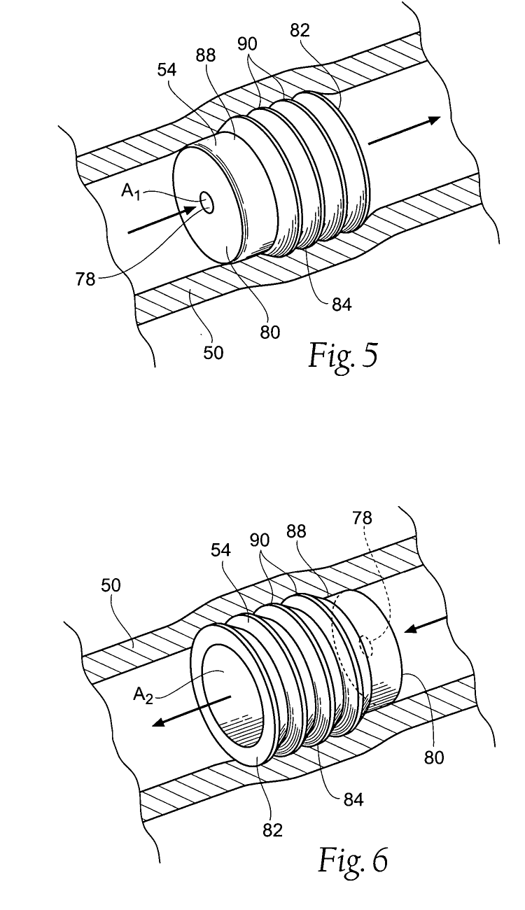

Referring further to FIG. 2, the head portion 26 is connected to the grip portion 28, preferably with the grip portion 28 threaded onto the head portion 26. The grip portion 28 houses fluid transporting means 50, which contains the fluid supply lines 14 and 18. The fluid transporting means 50 has a first end (not shown) in communication with the fluid supplies and a second end 50b connected to the head portion 26. The fluid transporting means 50 are connected to the head portion 26 by fastening means 52, which are depicted as threaded through bores. However, any fastening means 52, such as clamps, hooks, or adhesives that will connect the fluid transporting means 50 to the head portion 26 in a fluid-tight manner will be sufficiently within the scope of the present invention. The fluid transporting means 50 is shown as a dual tubular conduit, preferably made from a flexible material, so that there are separate conduits for each of the supply lines 14 and 18. Though the supply lines 14 and 18 are depicted as being within the same tubing structure, they may consist of unattached supply lines and still fall within the scope of the present invention. The supply lines 14 and 18 contain fluid pressure control fittings 54 and 56, respectively. The fittings 54 and 56 provide the necessary pressure regulation for the handpiece 10. The fittings 54 and 56 will be discussed further with respect to FIGS. 4 and 5.

FIG. 3 provides a partially cut-away side view of the head portion 26. The finger valve 32 and the cavity 46 are depicted, in connection with the first supply line 14, but the description and drawings are exemplary of the finger valve 34 and the cavity 48 and the second supply line 16 and all related elements (see FIG. 2), as well. As further described, the following reference numerals will refer to components of both cavities 46 and 48 and finger valves 32 and 34. A throughbore 58 having a first end 60 and a second end 62 traverses the head portion 26 and also intersects the cavity 46. The first end 60 of the throughbore 58 is in fluid communication with the socket 30 (shown in phantom). The second end 62 of the throughbore 58 is in fluid communication with the second end 50b of the fluid transporting means 50. Together, the throughbore 58 and the fluid transporting means 50 form a passageway 64 for fluid to flow from the source 12 to the dental attachment 24 (see FIG. 1). The pressure control fitting 54 is located within the passageway 64.

Still referring to FIG. 3, the finger valve 32 comprises a plunger 66 and a body 68. The body 68 resides within the cavity 46. The plunger 66 is located centrally of the body 68 and has a push button 70 located outwardly of the cavity 46 and also outwardly of the head portion 26 so that a person may manually operate the push button 70. In FIG. 3, the plunger 66 is in a normal position. The body 68 intersects the fluid passageway 64. The body 68 has a through opening 72 in communication with the throughbore 58. As shown, the plunger 66 inhibits fluid flow through the passageway 64, which prevents fluid from being delivered to the dental attachment 24.

The handpiece 10, as shown in FIG. 4, is similar to that of FIG. 3, except the push button 70 is now in a depressed position. The plunger 66 has a pathway 74 that allows fluid to travel upward into the plunger body 68 and exit through the opening 72 of the body 68. When the push button 70 is depressed, the passageway 64 is open, thereby allowing fluid to flow through the passageway 64. While the finger valve 32 is used to control flow of the fluid through the passageway 64, the fitting 54 (FIG. 3) controls and regulates the fluid pressure as it flows through the passageway 64 and the cavity 46. Thus, the fluid delivered by use of the finger valve 32 will at be a constant pressure.

FIGS. 5 and 6 show perspective views of the pressure control fitting 54. Unless indicated, the description and elements of the fitting 54 will apply to the fitting 56, as well. The fitting 54 is shown located within the fluid transporting means 50. The fitting 54 preferably has a cup-like shape. An orifice 78 located in a closed end 80 is located opposite an open end 82. A cylindrical wall 84 connects the closed end 80 and the open end 82. The orifice located in the closed end 80 has a first cross-sectional area A₁. The open end 82 has a second cross-sectional area A₂. The first cross-sectional area A₁ is significantly less than that of the second cross-sectional area A₂, which allows the fitting 54 and the A₁ area to regulate the pressure of the fluid as it passes through the fitting 54 to the head portion 26 and further to the dental attachment 24 (not shown). The measurements and dimensions of the areas A₁ and A₂ provide a constant pressure from the source to the dental attachment, regardless of what the fluid pressure is leaving the source. Preferably, the area A₂ is sufficient relative to the transporting means 50 so that regulation of the fluid is achieved specifically with the area A₁. Thus, the dental handpiece will be able to deliver a consistent, steady pressure to the attachment, without the operator of the handpiece needing to adjust the pressure releases at the fluid source.

Referring further to FIGS. 5 and 6, the wall 84 of the orifice 78 has an exterior surface 88. The exterior surface 88 has a plurality of ribs 90 that provide retention means for the fitting 54 within the fluid transport means 50. As previously stated, the fluid transport means 50 preferably comprises a flexible tube or elastomeric material. The overall diameter of the orifice may be slightly larger than the inner diameter of the transport means 50 so that the orifice 78 will not move when it comes in contact with a pressurized fluid from a fluid source. The ribs 90 will grip the sides of the elastomateric material and will retain the fitting 54 further.

The fitting 54 has been shown and described as being cuplike in shape. However, the fitting 54 may comprise the orifice 78 without including a further body structure. The fitting 54 could comprise a single disc with the orifice 78 located within the disc. The fitting could also be integrally formed with the transport means 50.

As shown, the orifice 78 is located centrally of the fitting 54 and relatively centrally of the transport means 50. Likewise, the orifice 78 preferably has a circular shape. The centrally located circular orifice 78 allows even fluid dispersion, which contributes to proper pressure regulation of a fluid traveling through the fitting 54.

While the area A₁ of the orifice 78 will be significantly less than the area A₂ of the open end 82 and also the interior cross-sectional area of the transport means 50, the area A₁ will vary according to the fluid being transported. For example the area A₁ of the orifice 78 will be proportionally larger to the cross-sectional area of the transport means 50 for a fluid such as water compared to the area A₁, for a fluid such as air. The area of the orifice 78 will be adjusted accordingly to the specific fluid traveling through the transport means 50 and to the desired pressure for that fluid.

It should be understood that dimensions for the present invention may vary according to the specific fluids and pressure settings required for specific dental procedures. Thus, as stated above, the dimensions of the orifice 78 and fitting 54 may vary according each fluid passing through the transport means 50 and still fall within the scope of the present invention. For example, in a typical dental environment, the area A₁ for the water flow may be approximately 0.0141″ and the area A₂ for the air flow may be 0.0071″. Provided a fitting located within the handpiece 10 allows for pressure regulation in the manner described, the pressure regulator will fall within the scope of the present invention. The invention uses predetermined cross-sectional areas for the pressure regulator to deliver fluid to a dental attachment at a constant temperature. Thus, the dental operator does not need to regulate pressure at the fluid source, which not only saves time in the procedure, but also provides for more consistent pressure from one procedure to the next.

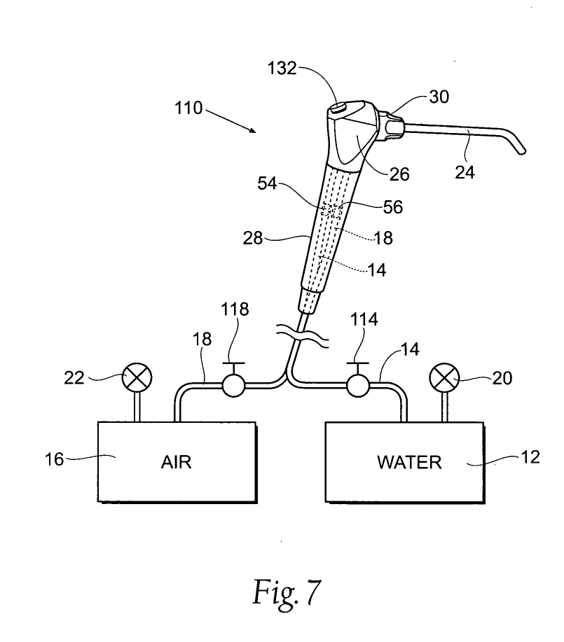

FIG. 7 also shows a further embodiment 110 of a dental handpiece according to the present invention. The handpiece 110 works substantially the same as the prior handpiece 10, except the handpiece 110 has a single finger valve 132. The single valve 132 may be used for delivery of different fluids, however. As in the previous embodiment, the handpiece 110 is connected to the air supply 16 and the water supply 12 with the supply lines 18 and 14, respectively. Likewise, the supply line 14 contains the fitting 54, and the supply line 18 contains the fitting 56. With the single valve 132, one of the fluid supplies 12 or 16 is closed, thereby allowing only one of the fluids to be delivered by the handpiece 110. The supply lines 14 and 18 may contain shutoff valves 114 and 118, respectively, or the fluid supplies may be turned off with the control valves 20 and 22. The fittings 54 and 56 still provide for fluid to be delivered at a proper pressure. It is also understood that the dental handpiece 110 may be connected to a single fluid source, or possibly more than two fluid sources, depending on the preferences of the user.

The foregoing is considered as illustrative only of the principles of the invention. Furthermore, since numerous modifications and changes will readily occur to those skilled in the art, it is not desired to limit the invention to the exact construction and operation shown and described. While the. preferred embodiment has been described, the details may be changed without departing from the invention, which is defined by the claims.

I claim:

1. A dental handpiece for delivering a fluid from a fluid source to a dental attachment under a regulated pressure, said handpiece comprising:
a head portion having a socket, said socket arranged to receive said dental attachment;
a fluid passageway having a first end in communication with said socket and a second end in communication with said fluid source; and
a fluid pressure control fitting residing in said passageway, said fitting having an orifice having a cross-sectional area less than said passageway interior cross-sectional area.

2. The dental handpiece according to claim 1 wherein said fitting is integrally formed with said passageway.

3. The dental hand piece according to claim 1 wherein said passageway further comprises:
a throughbore located in said head portion having a first end and a second end, said first end in communication with said socket; and
fluid transporting means having a first end and a second end, said first end in communication with said fluid source and said second end in communication with said second end of said throughbore.

4. The dental handpiece according to claim 3 wherein said fitting is located within said fluid transporting means.

5. The dental handpiece according to claim 4 wherein said fluid transporting means comprises a tubular conduit, said tubular conduit comprising a flexible material.

6. The dental handpiece according to claim 5, wherein the exterior surface of said fitting further comprises means for retention in said tube.

7. The dental handpiece according to claim 1, wherein said fitting comprises an open end and a closed end, said closed end including said orifice, said open end having a second cross-sectional area, said second cross-sectional area being greater than said orifice cross-sectional area.

8. The dental handpiece according to claim 7 wherein said fitting is cylindrical.

9. The dental handpiece according to claim 8 wherein said exterior surface comprises retention means for retaining said fitting in said passageway.

10. A dental handpiece for delivering a first fluid from a first fluid source and a second fluid from a second fluid source to a dental attachment, said fluids delivered under a regulated pressure, said handpiece comprising:
a head portion having a socket, said socket arranged to receive said dental attachment;
a first fluid passageway having a first end in communication with said socket and a second end in communication with said first fluid source.
a first control valve intersecting said first passageway for controlling fluid flow in said first passageway;
a first fluid pressure control fitting residing in said passageway, said fitting including an orifice, said orifice having an interior cross-sectional area less than said passageway cross-sectional area;
a second fluid passageway having a first end in communication with said socket and a second end in communication with said second fluid source;
a second control valve intersecting said second passageway for controlling fluid flow in said second passageway; and
a second fluid pressure control fitting residing in said second passageway, said fitting having an orifice, said orifice having a cross-sectional area less than said second passageway cross-sectional area.

11. The dental hand piece according to claim 10 wherein said first passageway further comprises:
a first throughbore located in said head portion having a first end and a second end, said first end in communication with said socket; and
first fluid transporting means having a first end and a second end, said first end in communication with said first fluid source and said second end in communication with said second end of said first throughbore.

12. The dental handpiece according to claim 11, wherein said second passageway further comprises:
a second throughbore located in said head portion having a first end and a second end, said first end in communication with said socket; and
second fluid transporting means having a first end and a second end, said first end in communication with said second fluid source and said second end in communication with said second end of said second throughbore.

13. The dental handpiece according to claim 12 wherein said first fitting is located within said first fluid transporting means and said second fitting is located with said second fluid transporting means.

14. The dental handpiece according to claim 13 wherein said first and said second fluid transporting means each comprises a tubular conduit, said tubular conduits comprising a flexible material.

15. The dental handpiece according to claim 14, wherein each of said fittings further comprises means for retaining each if said fittings in each of said tubes.

16. The dental handpiece according to claim 10, wherein said each of said fitting comprises an open end and a closed end, said closed end including said respective orifice, said open end having a second cross-sectional area, said second cross-sectional area being greater than said orifice cross-sectional area.

17. A dental handpiece for delivering a fluid from a fluid source to a dental attachment under a regulated pressure, said handpiece comprising:
a head portion having a socket, said socket arranged to receive said dental attachment;
a fluid passageway having a first end in communication with said socket and a second end in communication with said fluid source;
a control valve intersecting said passageway for controlling fluid flow in said passageway; and
a fluid pressure control fitting residing in said passageway, said fitting having an orifice having a cross-sectional area less than said passageway interior cross-sectional area.

18. The dental handpiece according to claim 17 wherein said fitting is integrally formed with said passageway.

19. The dental hand piece according to claim 17 wherein said passageway further comprises:
a throughbore located in said head portion having a first end and a second end, said first end in communication with said socket; and
fluid transporting means having a first end and a second end, said first end in communication with said fluid source and said second end in communication with said second end of said throughbore.

20. The dental handpiece according to claim 17, wherein said fitting comprises an open end and a closed end, said closed end including said orifice, said open end having a second cross-sectional area, said second cross-sectional area being greater than said orifice cross-sectional area, said fitting further comprises means for retention in said passageway.
